(19) United States
(12) Patent Application Publication
(10) Pub. No.: US 2026/0150085 A1
(43) Pub. Date: May 28, 2026

(54) METHOD AND DEVICE FOR SUPPORTING SIB-LESS CELL IN NEXT GENERATION MOBILE COMMUNICATION

(71) Applicant: Samsung Electronics Co., Ltd., Suwon-si, Gyeonggi-do (KR)

(72) Inventors: Sangbum KIM, Suwon-si (KR); Sangkyu BAEK, Suwon-si (KR); Sangyeob JUNG, Suwon-si (KR)

(21) Appl. No.: 19/122,027

(22) PCT Filed: Dec. 19, 2023
(86) PCT No.: PCT/KR2023/020985

§ 371 Date: Apr. 17, 2025

(30) Foreign Application Priority Data
Dec. 23, 2022 (KR) 10-2022-0182667

(51) Int. Cl. H04W 68/02; H04W 48/14

(52) U.S. Cl. CPC H04W 68/02; H04W 48/14

(57) ABSTRACT

The present disclosure relates to a 5G or 6G communication system for supporting higher data transmission rates. The present disclosure relates to a method performed by means of a terminal in a wireless communication system, the method comprising identifying a system information block (SIB)-less cell, requesting an SIB for the SIB-less cell from an anchor cell corresponding to the SIB-less cell, receiving the SIB for the SIB-less cell from the anchor cell, receiving a paging message for the SIB-less cell from the anchor cell, the paging message including an indicator that indicates access to the SIB-less cell, and attempting to access the SIB-less cell on the basis of the paging message.

### TECHNICAL FIELD

The disclosure relates to a mobile communication system, and more particularly, to operations of a terminal and a base station for supporting a system information block (SIB)-less cell in a mobile communication system.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Problem

According to an embodiment, the disclosure provides a method and device for supporting an SIB-less cell.

### Technical Solution

In accordance with an aspect of the disclosure, a method performed by a terminal in a wireless communication system comprises identifying a system information block (SIB)-less cell, requesting an SIB for the SIB-less cell from an anchor cell corresponding to the SIB-less cell, receiving the SIB for the SIB-less cell from the anchor cell, receiving a paging message for the SIB-less cell from the anchor cell, the paging message including an indicator that indicates access to the SIB-less cell, and attempting to access the SIB-less cell based on the paging message.

In accordance with another aspect of the disclosure, a method performed by a base station related to an anchor cell includes receiving a request an SIB for an SIB-less cell from a terminal, transmitting the SIB for the SIB-less cell to the terminal, and transmitting a paging message for the SIB-less cell to the terminal, wherein the paging message includes an indicator that indicates access to the SIB-less cell.

In accordance with still another aspect of the disclosure, a terminal in a wireless communication system includes a transceiver, and a controller, wherein the controller is configured to identify an SIB-less cell, request an SIB for the SIB-less cell from an anchor cell corresponding to the SIB-less cell, receive the SIB for the SIB-less cell from the anchor cell, receive a paging message for the SIB-less cell from the anchor cell, the paging message including an indicator that indicates access to the SIB-less cell, and attempt to access the SIB-less cell based on the paging message.

In accordance with still another aspect of the disclosure, a base station corresponding to an anchor cell in a wireless communication system comprises a transceiver, and a controller, wherein the controller is configured to receive a request of an SIB for an SIB-less cell from a terminal, transmit the SIB for the SIB-less cell to the terminal, and transmit a paging message for the SIB-less cell to the terminal, wherein the paging message includes an indicator that indicates access to the SIB-less cell.

### Advantageous Effects

According to a method for supporting an SIB-less cell proposed by the disclosure, power consumption of network equipment and a terminal can be reduced and efficient data transmission and reception can be achieved.

### DESCRIPTION OF DRAWINGS

FIG. 1 illustrates a structure of a next-generation mobile communication system according to an embodiment of the disclosure.

FIG. 2 is a diagram illustrating the concept of a system information block (SIB)-less cell according to an embodiment of the disclosure.

FIG. 3 is a diagram illustrating an operation of receiving SIBs and paging of an SIB-less cell through an anchor cell according to an embodiment of the disclosure.

FIG. 4 is a flowchart illustrating an operation of receiving SIBs and paging of an SIB-less cell through an anchor cell according to an embodiment of the disclosure.

FIG. 5 is a flowchart illustrating the operation of a network energy saving (NES) UE according to an embodiment of the disclosure.

FIG. 6 is a flowchart illustrating the operation of an SIB-less cell according to an embodiment of the disclosure.

FIG. 7 is a flowchart illustrating the operation of an anchor cell according to an embodiment of the disclosure.

FIG. 8 is a block diagram illustrating an internal structure of a UE according to an embodiment of the disclosure.

FIG. 9 is a block diagram illustrating a structure of a base station according to an embodiment of the disclosure.

### MODE FOR INVENTION

In describing the disclosure below, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

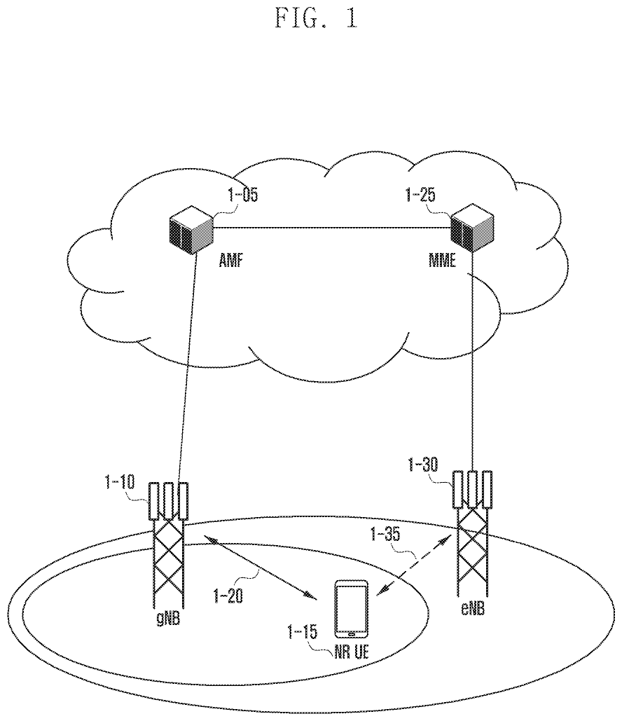

FIG. 1 illustrates a structure of a next-generation mobile communication system according to an embodiment of the disclosure.

Referring to FIG. 1, as illustrated therein, a radio access network of a next-generation mobile communication system (new radio, NR) includes a next-generation base station (new radio node B, hereinafter gNB) 1-10 and an AMF (new radio core network) 1-05. A user equipment (new radio user equipment, hereinafter NR UE or terminal) 1-15 accesses an external network via the gNB 1-10 and the AMF 1-05.

In FIG. 1, the gNB corresponds to an evolved node B (eNB) of a conventional LTE system. The gNB may be connected to the NR UE through a radio channel and provide outstanding services as compared to a conventional node B (1-20). In the next-generation mobile communication system, since all user traffic is serviced through a shared channel, a device that collects state information, such as buffer statuses, available transmit power states, and channel states of UEs, and performs scheduling accordingly is required, and the gNB 1-10 serves as the device. In general, one gNB controls multiple cells. In order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system employs an adaptive modulation & coding (hereinafter referred to as AMC) scheme for determining a modulation scheme and a channel coding rate according to a channel state of a UE. The AMF 1-05 performs functions such as mobility support, bearer configuration, and QoS configuration. The AMF is a device responsible for various control functions as well as a mobility management function for a UE, and isa connected to multiple base stations. In addition, the next-generation mobile communication system may interwork with the existing LTE system, and the AMF is connected to an MME 1-25 via a network interface. The MME is connected to an eNB 1-30 that is an existing base station. A UE supporting LTE-NR dual connectivity (EN-DC) may transmit/receive data while maintaining connections to both the gNB and the eNB (1-35).

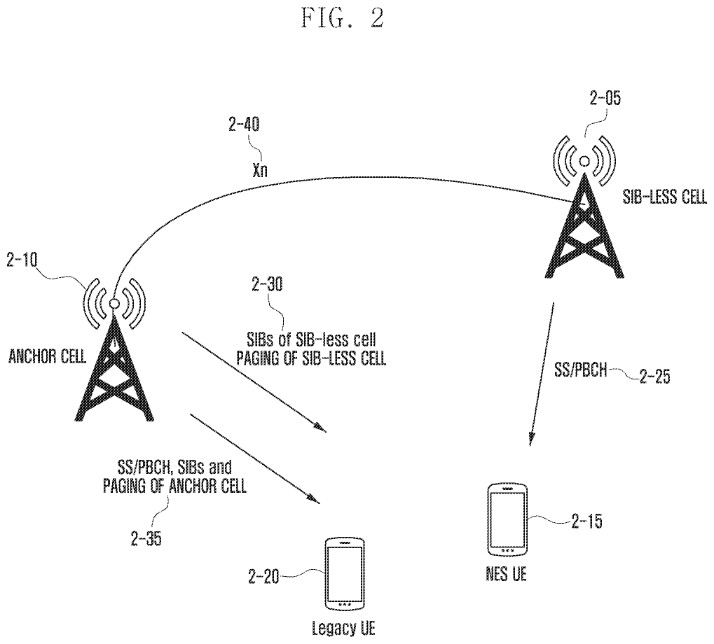

FIG. 2 is a diagram illustrating the concept of a system information block (SIB)-less cell according to an embodiment of the disclosure.

An SIB-less cell 2-05 refers to a cell that does not broadcast SIB for the purpose of saving power consumption of network equipment. In addition, the SIB-less cell 2-05 may not transmit paging. Instead, an anchor cell 2-10 located around the SIB-less cell 2-05 may transmit SIBs and paging 2-30 of the SIB-less cell. The SIB-less cell and the anchor cell are connected to each other through a predetermined interface (e.g., Xn) and transmit and receive necessary predetermined information in operation 2-40. In this embodiment, it is assumed that the SIB-less cell still broadcasts SSB and MIB (i.e., SS/PBCH, 2-25). A network energy saving (NES) UE 2-15 supporting the above SIB-less cell may determine whether the cell is an SIB-less cell through information included in the MIB broadcasted by the SIB-less cell, and acquire SIBs and paging of the SIB-less cell from the surrounding anchor cell. The existing terminal 2-20 cannot distinguish between the SIB-less cell and the existing cell. However, the existing terminal may consider the cell as barred because the SIB-less cell is not broadcasting the SIB. Alternatively, the SIB-less cell can be barred so that the existing terminal does not (re)select the cell, through information included in the MIB of the SIB-less cell.

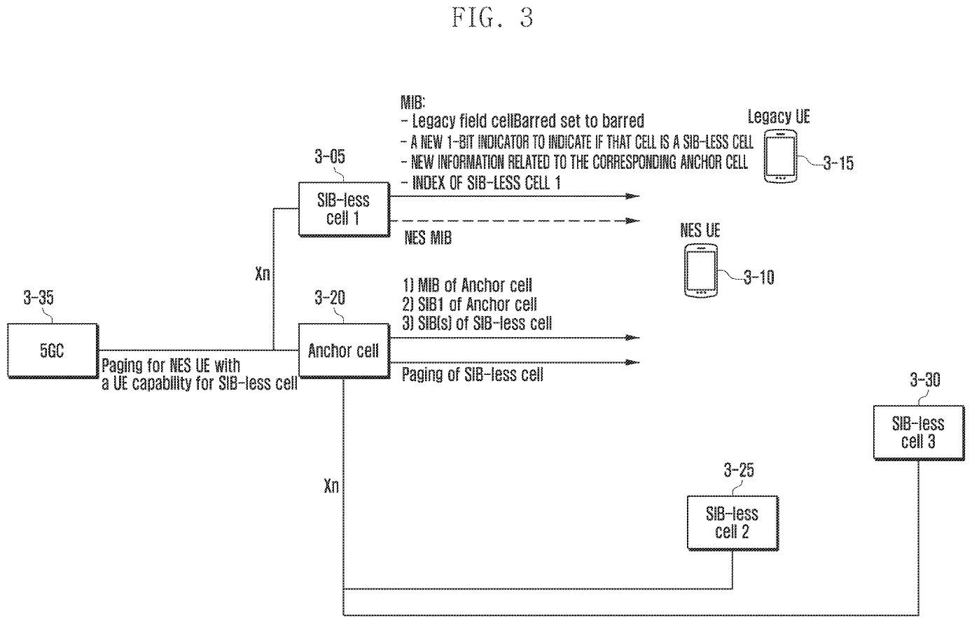

FIG. 3 is a diagram illustrating an operation of receiving SIBs and paging of an SIB-less cell through an anchor cell according to an embodiment of the disclosure.

An SIB-less cell 3-05 broadcasts SSB and MIB. A conventional MIB contains the following information (see TS38.331 ASN.1 excerpt below):

| -- ASN1START | |
|---|---|
| -- TAG-MIB-START | |
| MIB ::= | SEQUENCE { |
| systemFrameNumber | BIT STRING (SIZE (6)), |
| subCarrierSpacingCommon | ENUMERATED (scs15or60, scs30or120), |
| ssb-SubcarrierOffset | INTEGER (0..15), |
| dmrs-TypeA-Position | ENUMERATED (pos2, pos3), |
| pdcch-ConfigSIB1 | PDCCH-ConfigSIB1, |
| cellBarred | ENUMERATED (barred, notBarred), |
| intraFreqReselection | ENUMERATED (allowed, notAllowed), |
| spare | BIT STRING (SIZE (1)) |

}
-- TAG-MIB-STOP
-- ASN1STOP

At this time, the SIB-less cell configures the existing cellBarred field of the MIB to “barred” so that existing terminals 3-15 cannot camp-on the cell. In addition, the MIB includes one bit of spare bit. The spare bit of the MIB is used as an indicator that indicates whether the cell is an SIB-less cell to NES UEs 3-10 supporting the SIB-less cell. At this time, when the indicator indicating that the cell is the SIB-less cell is included in the MIB, the NES UEs ignore the cellBarred field information. That is, even if the cellBarred field is configured to “barred,” the NES UEs do not consider the cell as barred. The MIB includes unnecessary information in the SIB-less cells. That is, fields such as subCarrierSpacingCommon, ssb-subcarrierOffset, dmrs-TypeA-Position, and pdcch-ConfigSIB1 are information required for subsequent operations such as SIB1 reception after the reception of the MIB, and are unnecessary in the SIB-less cell. Therefore, in the present embodiment, the bits allocated to the fields are not used for their original purposes, but are used to indicate SIB-less cell and anchor cell-related information corresponding to the SIB-less cell.

The SIB-less cell and anchor cell-related information included in the MIB may include one of the following pieces of information:
Index or ID information of the SIB-less cell.

A single anchor cell may transmit SIBs and paging of one or more SIB-less cells. Therefore, a single piece of index or ID information (e.g., physical cell ID (PCI), cell global identifier (CGI), etc.) is required to distinguish each SIB-less cell corresponding to the anchor cell. In addition, an ID (TAC or TAI) of the tracking area of the corresponding SIB-less cell and ID information of an RAN-based notification area may be included.
Random access radio resource information

For a predetermined purpose, the NES UE may perform random access to the SIB-less cell without communicating with the anchor cell (e.g., receiving paging indicating access to the SIB-less cell, etc.). The predetermined purpose may include a case in which the NES UE cannot search for an anchor cell satisfying a predetermined signal strength quality around the SIB-less cell, a case in which access is triggered for an emergency call, a case in which access is triggered for a tacking area uplink (TAU) or RAN-based notification area (RNA) update, a case in which a signal requesting activation of a base station in a sleep mode is transmitted for power saving purpose, etc.

The above random access radio resource information may include radio resource information in the time and frequency axes at which the NES UE can transmit a preamble to the SIB-less cell. A dedicated preamble may be configured according to the above-mentioned predetermined purpose. For example, among the total 64 preambles, the 1st to 32nd preambles may be used when an anchor cell satisfying a predetermined signal strength quality is not searched around the SIB-less cell.
Information required to access the anchor cell

The information may include at least one of ID information (e.g., PCI, CGI, etc.) or frequency information (e.g., ARFCN-ValueNR, etc.) of the anchor cell corresponding to the SIB-less cell, some information (e.g., subCarrierSpacingCommon, ssb-subcarrierOffset, dmrs-TypeA-Position, pdcch-ConfigSIB1 information, etc.) included in the MIB of the anchor cell to quickly acquire SIB1 broadcasted from the anchor cell, and threshold information of the minimum reception signal strength required to camp-on to the anchor cell (when the reception signal strength of the anchor cell is lower than the threshold, the NES UE may consider the anchor cell as invalid).

Information required to access the SIB-less cell. The information may include at least one of a new cellBarred field and an intraFreqReselection field to prevent an NES UE from camping on the SIB-less cell, and information on a threshold of the minimum reception signal strength required to access the SIB-less cell (when the reception signal strength of the SIB-less cell is lower than the threshold, the NES UE may consider the SIB-less cell as invalid).
Information required to receive a new NES MIB

Even when the existing fields in the conventional MIB are used to configure the above-mentioned new information, the number of bits required to include the new information may be insufficient. Therefore, a dedicated NES MIB that is broadcasted only by the SIB-less cell may be defined separately. The NES MIB may include the above information related to the SIB-less cell and the anchor cell mentioned in the present embodiment. The NES MIB may be broadcasted according to a predetermined scheduling, or the MIB may include scheduling information for the NES MIB. When the NES MIB is broadcasted according to the predetermined scheduling, an indicator indicating that the NES MIB is being broadcasted may be included in the conventional MIB broadcasted by the SIB-less cell.

An anchor cell 3-20 broadcasts its own MIB and SIB(s) according to the conventional technology. In addition, the anchor cell may broadcast even the SIB of the SIB-less cell. The anchor cell may also broadcast the SIBs of one or more SIB-less cells 3-05, 3-25, and 3-30, and in order to effectively provide this to the NES UE, an on-demand SI method can be utilized. The SIB1 or new SIB of the anchor cell may be broadcasted including scheduling information of SI messages composed of the SIB(s) of the SIB-less cell(s). The scheduling information may include an indicator indicating whether the respective SI messages of the current SIB-less cell(s) are being broadcasted. In addition, index information indicating which SIB-less cell corresponds to each SI message or a group of predetermined SI messages may be included. The SIB1 or new SIB of the anchor cell may include information on SIB-less cells managed by the anchor cell. The above information includes ID information (e.g., PCI, CGI, etc.), index information, frequency information (e.g., ARFCN-ValueNR, etc.) of the above SIB-less cell.

The anchor cell belongs to the same tracking area (TA) or RAN-based notification area (RNA) as the SIB-less cell(s). A core network 5GC 3-35 of NR transmits a capability indicator indicating whether the terminal is the NES UE or a capability indicator indicating whether the terminal supports the SIB-less cell while transmitting paging for the NES UE to the anchor cell.

The anchor cell that has received the paging transmits the paging message to the NES UE. At this time, the anchor cell may determine whether to allow the terminal to access the anchor cell itself or to access a specific SIB-less cell. The paging message is a common signaling, and each paging record in the paging message may include an indicator that indicates to attempt to access a specific SIB-less cell, not the anchor cell. The above indicator may indicate a specific SIB-less cell (among a plurality of SIB-less cells) that the NES UE should attempt to access. Alternatively, an NES UE-dedicated paging message that only the NES UE receives may be defined. Scheduling information (e.g., paging cycle, etc.) of the NES UE-dedicated paging message may be provided in SIB1 of the anchor cell. The NES UE that has received the paging message including the above indicator determines whether to attempt to access the anchor cell that transmitted the paging message or to attempt to access the specific SIB-less cell.

When the terminal performs random access to the specific SIB-less cell, certain information such as radio resource information of the random access is required, and the random access radio resource information of each SIB-less cell is included in a specific SIB of the anchor cell broadcasted by the anchor cell or a specific SIB of the SIB-less cell broadcasted by the anchor cell.

On the other hand, even when there is an indicator that indicates access to the specific SIB-less cell in the paging message, the NES UE may attempt to access the anchor cell in certain cases. The certain cases are a case in which the random access is not successfully completed in the SIB-less cell because the signal strength/quality of the indicated SIB-less cell does not satisfy a specific threshold, or a case in which it is considered that general service cannot be provided, or a case in which a long delay time is expected to be consumed until access completion because the SIB of the SIB-less cell is not acquired in advance. The specific threshold may be provided through the MIB of the corresponding SIB-less cell, the NES MIB, or the SIB of the corresponding SIB-less cell provided by the anchor cell.

The NES UE may perform random access to the anchor cell. At this time, the NES UE uses the random access radio resource indicated in the SIB1 of the anchor cell for the purpose of the random access. The NES UE may report information (e.g., ID information, frequency information, PCI, CGI or index, reception strength measurement information, RSRP/RSRQ, etc., of the SIB-less cell) on the surrounding SIB-less cells which can be connected to the NES UE or recognized, to the anchor cell through an uplink message (e.g., Msg3) during the random access process or a predetermined RRC message (e.g., RRCSetupComplete or RRCResumeComplete message, etc.) after the random access process. In addition, when random access to the anchor cell, which is not the configured SIB-less cell, is performed, the terminal may report a cause value indicating the reason to the anchor cell through a Msg3 message or a predetermined RRC message.

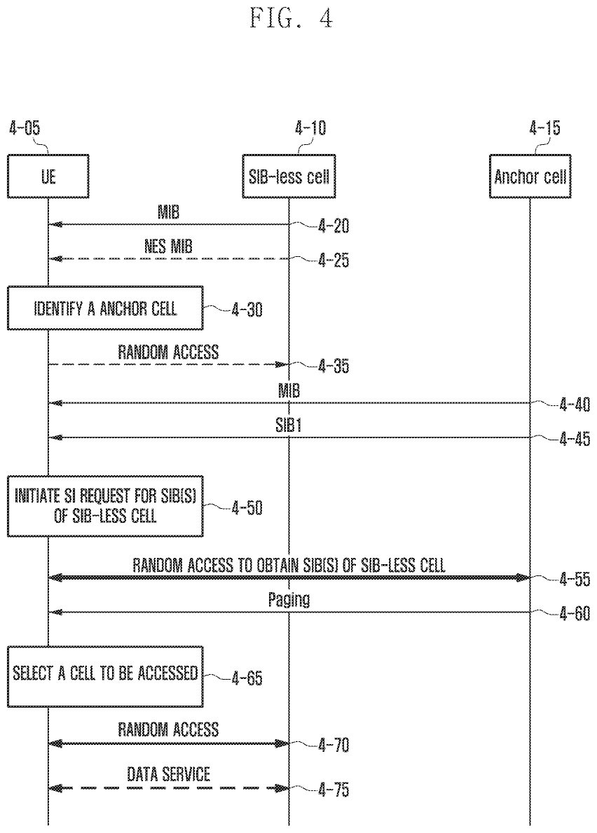

FIG. 4 is a flowchart illustrating an operation of receiving SIBs and paging of an SIB-less cell through an anchor cell according to an embodiment of the disclosure.

A terminal 4-05 detects an SIB-less cell 4-10. The terminal receives an MIB broadcasted by the SIB-less cell in operation 4-20 and determines whether the cell is the SIB-less cell through certain information included in the MIB. The terminal may also receive an NES MIB (4-25, a type of system information) additionally broadcasted by the SIB-less cell. However, as described above, the receiving of the NES MIB may be omitted depending on the configuration of the MIB.

The terminal may identify a surrounding anchor cell 4-15 corresponding to the SIB-less cell through the information included in the MIB or NES MIB in operation 4-30. When the terminal fails to search for the surrounding anchor cell, the terminal performs a random access to the SIB-less cell and informs that the anchor cell cannot be searched in operation 4-35. To this end, the SIB-less cell provides information (random access radio resources, etc.) for performing the random access through the MIB or NES MIB, and the terminal may transmit an indicator or cause value indicating the cause to the SIB-less cell during the random access process. In addition to the above cause, the random access radio resources may be used to perform a random access to the SIB-less cell for the purpose of an emergency call, TAU or RNA update, or UE triggered WUS transmission.

The random access radio resources provided by the SIB-less cell through the MIB or NES MIB may be different from the radio resources for the random access performed according to paging transmitted by the anchor cell. The radio resource information for the random access performed according to the paging transmitted by the anchor cell is provided through system information transmitted by the anchor cell.

The terminal receives MIB and SIB1 related to the anchor cell from the anchor cell in operations 4-40 and 4-45. The terminal acquires scheduling information for SIB(s) of the SIB-less cell included in the SIB1 of the anchor cell. When an SI request operation is required to acquire the SIB(s) of the SIB-less cell, the terminal triggers (or initiates) the operation in operation 4-50. The SI request operation means an operation of requesting, from the base station, transmission of an SI message that is not currently being broadcasted, using Msg1 (preamble) or Msg3 during the random access process. The terminal performs a random access for the purpose of SI request to the anchor cell to acquire the SIB(s) of the SIB-less cell in operation 4-55.

The terminal receives paging from the anchor cell in operation 4-60. The paging message includes an indicator indicating whether to perform a random access for accessing the SIB-less cell. According to the indicator, the terminal performs the random access to the SIB-less cell in operation 4-70. When the random access is successfully completed, the terminal receives a data transmission service from the SIB-less cell in operation 4-75.

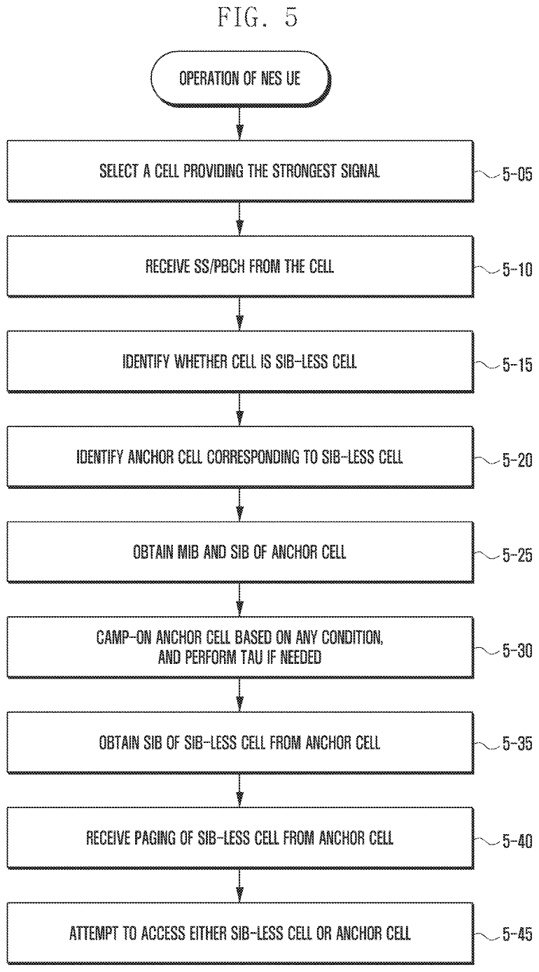

FIG. 5 is a flowchart illustrating the operation of a network energy saving (NES) UE according to an embodiment of the disclosure.

In operation 5-05, the terminal selects one cell providing the strongest signal.

In operation 5-10, the terminal receives SS/PBCH transmitted from the selected cell. The PBCH includes MIB information.

In operation 5-15, the terminal determines whether the selected cell is an SIB-less cell from predetermined information included in the received MIB. Specifically, a method in which the MIB includes information indicating whether the selected cell is the SIB-less cell is the same as described above, so it is omitted below.

In operation 5-20, the terminal searches for an anchor cell that provides a sufficiently strong signal strength corresponding to the SIB-less cell based on the predetermined information included in the received MIB. When the anchor cell is not detected or the detected anchor cell does not provide a sufficiently strong signal strength, the terminal may inform the SIB-less cell that there is no suitable anchor cell in the vicinity. In this case, the terminal may consider the SIB-less cell as barred.

In operation 5-25, the terminal obtains MIB and SIB from the selected anchor cell.

In operation 5-30, the terminal camps-on an anchor cell that satisfies the predetermined condition. Even when the anchor cell does not provide the strongest signal at a corresponding serving frequency, the terminal may camp-on the anchor cell. If necessary, the terminal may perform a TAU or RNA update operation on the anchor cell.

In operation 5-35, the terminal obtains the SIB of the SIB-less cell from the anchor cell. When the SIB of the SIB-less cell is not being broadcasted, the terminal may perform an SI request operation to request the SIB from the anchor cell.

In operation 5-40, the terminal receives a paging message from the anchor cell.

In operation 5-45, the terminal selects either the anchor cell or the SIB-less cell through an indicator included in the paging message or a separate paging message, and performs an access operation.

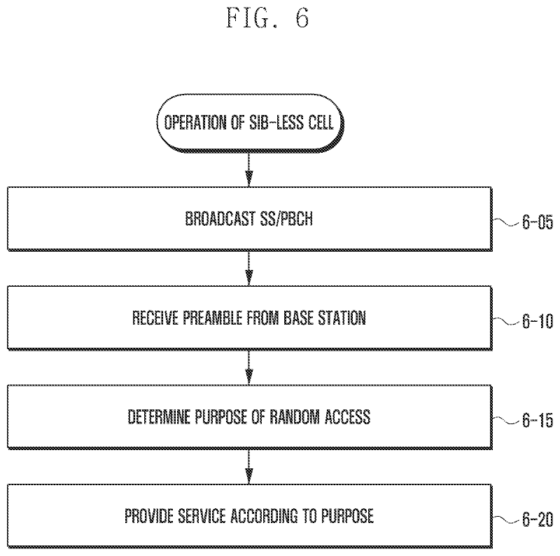

FIG. 6 is a flowchart illustrating the operation of an SIB-less cell according to an embodiment of the disclosure.

In operation 6-05, a base station broadcasts SS/PBCH and does not broadcast existing SIBs. If necessary, the base station may additionally broadcast an NES MIB containing certain system information.

In operation 6-10, the base station receives a preamble from the terminal.

In operation 6-15, the base station may determine the purpose of the terminal attempting to access the base station by considering the received preamble, used random access radio resources, and the information included in Msg3 during a random access process.

In operation 6-20, the base station provides an appropriate service to the terminal according to the determined purpose.

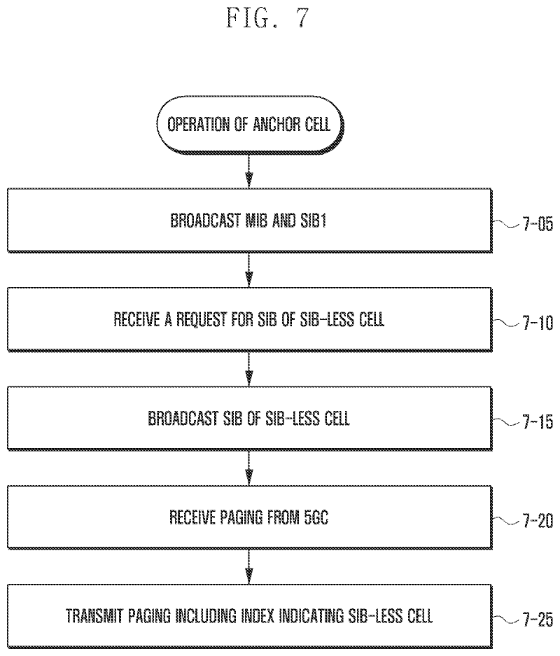

FIG. 7 is a flowchart illustrating the operation of an anchor cell according to an embodiment of the disclosure.

In operation 7-05, a base station broadcasts an MIB and SIB1. The SIB1 includes scheduling information of an SI message composed of SIB(s) of a specific SIB-less cell.

In operation 7-10, the base station receives a request from a terminal to broadcast an SI message composed of SIB(s) of a specific SIB-less cell.

In operation 7-15, the base station broadcasts an SI message composed of the SIB(s) of the specific SIB-less cell according to the request.

In operation 7-20, the base station receives paging for a specific terminal from 5GC. Along with the paging, the terminal may be provided with an indicator indicating that the terminal supports the SIB-less cell.

In operation 7-25, the base station transmits a paging message including an indicator indicating the SIB-less cell that the terminal should attempt to access, to the terminal.

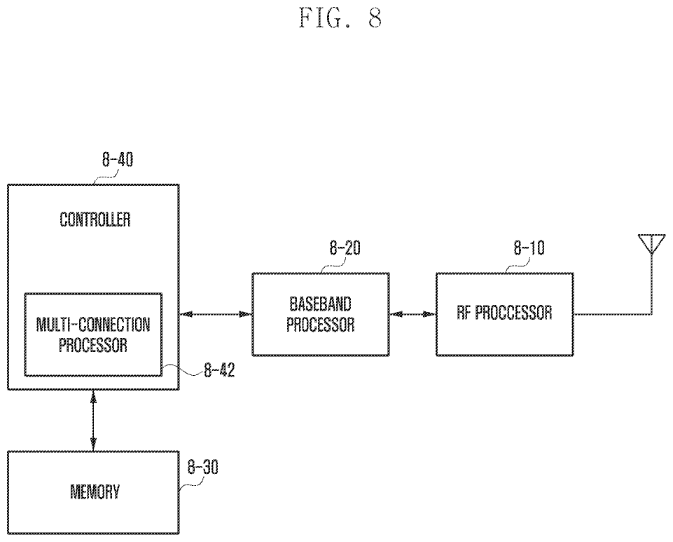

FIG. 8 is a block diagram illustrating an internal structure of a UE according to an embodiment of the disclosure.

Referring to FIG. 8, the UE may include a radio frequency (RF) processor 8-10, a baseband processor 8-20, a memory 8-30, and a controller 8-40.

The RF processor 8-10 may perform functions for transmitting/receiving signals through a radio channel, such as signal band conversion and amplification. That is, the RF processor 8-10 may up-convert a baseband signal provided from the baseband processor 8-20 to an RF band signal, may transmit the same through an antenna, and may down-convert an RF band signal received through the antenna to a baseband signal. For example, the RF processor 8-10 may include a transmission filter, a reception filter, an amplifier, a mixer, an oscillator, a digital-to-analog converter (DAC), an analog-to-digital converter (ADC), and the like. Although only one antenna is illustrated in the drawing, the UE may include multiple antennas. In addition, the RF processor 8-10 may include multiple RF chains. Furthermore, the RF processor 8-10 may perform beamforming. For the beamforming, the RF processor 8-10 may adjust the phase and magnitude of signals transmitted/received through multiple antennas or antenna elements, respectively. In addition, the RF processor may perform MIMO, and may receive multiple layers when performing a MIMO operation.

The baseband processor 8-20 may perform functions of conversion between baseband signals and bitstrings according to the physical layer specifications of the system. For example, during data transmission, the baseband processor 8-20 may encode and modulate a transmitted bitstring to generate complex symbols. In addition, during data reception, the baseband processor 8-20 may demodulate and decode a baseband signal provided from the RF processor 8-10 to restore a received bitstring. For example, when following the orthogonal frequency division multiplexing (OFDM) scheme, during data transmission, the baseband processor 8-20 may encode and modulate a transmitted bitstring to generate complex symbols, may map the complex symbols to subcarriers, and may configure OFDM symbols through inverse fast Fourier transform (IFFT) operation and cyclic prefix (CP) insertion. In addition, during data reception, the baseband processor 8-20 may split a baseband signal provided from the RF processor % n at the OFDM symbol level, may restore signals mapped to subcarriers through a fast Fourier transform (FFT) operation, and may restore a received bitstring through demodulation and decoding.

The baseband processor 8-20 and the RF processor 8-10 may transmit and receive signals as described above. Therefore, the baseband processor 8-20 and the RF processor 8-10 may be referred to as a transmitter, a receiver, a transceiver, or a communication unit. Furthermore, at least one of the baseband processor 8-20 and the RF processor 8-10 may include multiple communication modules to support multiple different radio access technologies. In addition, at least one of the baseband processor 8-20 and the RF processor 8-10 may include different communication modules to process signals in different frequency bands. For example, the different radio access technologies may include wireless LANs (for example, IEEE 802.11), cellular networks (for example, LTE), and the like. In addition, the different frequency bands may include super high frequency (SHF) (e.g., 2 NRHz) bands and millimeter wave (mmWave) (e.g., 60 GHz) bands.

The memory 8-30 stores data such as basic programs for operation of the UE, application programs, and configuration information. Particularly, the memory 8-30 may store information regarding a second access node configured to perform wireless communication by using a second radio access technology. In addition, the memory 8-30 may provide the stored data at the request of the controller 8-40.

The controller 8-40 controls the overall operation of the UE. For example, the controller 8-40 may transmit/receive signals through the baseband processor 8-20 and the RF processor 8-10. In addition, the controller 8-40 records data in the memory 8-30 and reads the data from the memory 8-30. To this end, the controller 8-40 may include at least one processor. For example, the controller 8-40 may include a communication processor (CP) configured to perform control for communication, and an application processor (AP) configured to control upper layers such as application programs.

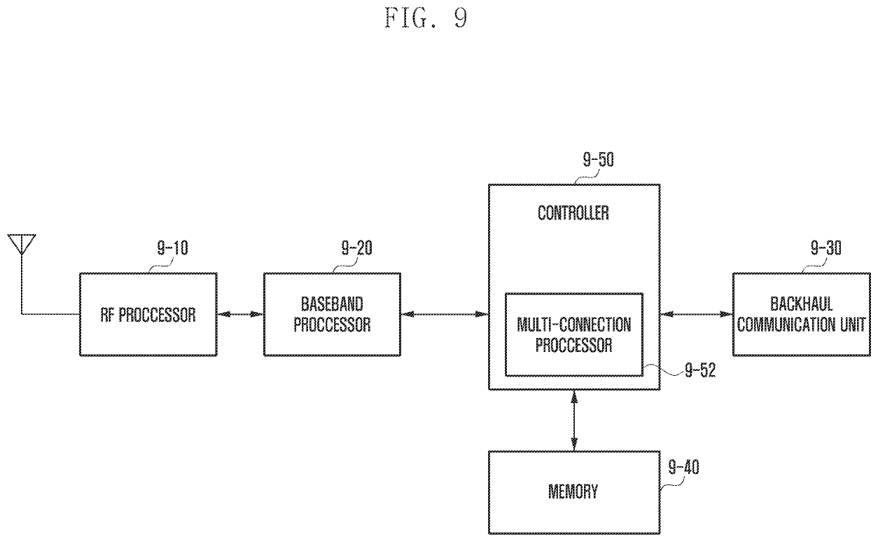

FIG. 9 is a block diagram illustrating a structure of a base station according to an embodiment of the disclosure.

Referring to FIG. 9, the base station may include an RF processor 9-10, a baseband processor 9-20, a backhaul communication unit 9-30, a memory 9-40, and a controller 9-50.

The RF processor 9-10 may perform functions for transmitting/receiving signals through a radio channel, such as signal band conversion and amplification. That is, the RF processor 9-10 may up-convert a baseband signal provided from the baseband processor 9-20 to an RF band signal, may transmit the same through an antenna, and may down-convert an RF band signal received through the antenna to a baseband signal. For example, the RF processor 9-10 may include a transmission filter, a reception filter, an amplifier, a mixer, an oscillator, a DAC, and an ADC. Although only one antenna is illustrated in the drawing, the first access node may include multiple antennas. In addition, the RF processor 9-10 may include multiple RF chains. Furthermore, the RF processor 9-10 may perform beamforming. For the beamforming, the RF processor 9-10 may adjust the phase and magnitude of signals transmitted/received through multiple antennas or antenna elements, respectively. The RF processor may transmit one or more layers to perform a downward MIMO operation.

The baseband processor 9-20 may perform functions of conversion between baseband signals and bitstrings according to the physical layer specifications of first radio access technology. For example, during data transmission, the baseband processor 9-20 may encode and modulate a transmitted bitstring to generate complex symbols. In addition, during data reception, the baseband processor 9-20 may demodulate and decode a baseband signal provided from the RF processor 9-10 to restore a received bitstring. For example, when following the OFDM scheme, during data transmission, the baseband processor 9-20 may encode and modulate a transmitted bitstring to generate complex symbols, may map the complex symbols to subcarriers, and may configure OFDM symbols through IFFT operation and CP insertion. In addition, during data reception, the baseband processor 9-20 may split a baseband signal provided from the RF processor 9-10 at the OFDM symbol level, may restore signals mapped to subcarriers through FFT operation, and may restore a received bitstring through demodulation and decoding. The baseband processor 9-20 and the RF processor 9-10 may transmit and receive signals as described above. Therefore, the baseband processor 9-20 and the RF processor 9-10 may be referred to as a transmitter, a receiver, a transceiver, or a communication unit.

The backhaul communication unit 9-30 provides an interface for communicating with other nodes in the network. That is, the backhaul communication unit 9-30 converts bitstrings transmitted from the main base station to other nodes, for example, an auxiliary base station, a core network, etc., into physical signals, and converts physical signals received from the other nodes into bitstrings.

The memory 9-40 may store data such as basic programs for operation of the main base station, application programs, and configuration information. Particularly, the memory 9-40 may store information regarding a bearer allocated to a connected UE, a measurement result reported from the connected UE, and the like. In addition, the memory 9-40 may store information serving as a reference to determine whether to provide multi-connection to a UE or to suspend the same. In addition, the memory 9-40 may provide the stored data at the request of the controller 9-50.

The controller 9-50 controls the overall operation of the main base station. For example, the controller 9-50 transmits/receives signals through the baseband processor 9-20 and the RF processor 9-10 or through the backhaul communication unit 9-30. In addition, the controller 9-50 records data in the memory 9-40 and reads the data from the memory 9-40. To this end, the controller 9-50 may include at least one processor.

1. A method performed by a terminal in a wireless communication system, the method comprising:
identifying a system information block (SIB)-less cell;
requesting an SIB for the SIB-less cell from an anchor cell corresponding to the SIB-less cell;
receiving the SIB for the SIB-less cell from the anchor cell;
receiving a paging message for the SIB-less cell from the anchor cell, the paging message including an indicator that indicates access to the SIB-less cell; and
attempting to access the SIB-less cell based on the paging message.

2. The method of claim 1,
wherein the identifying of the SIB-less cell comprises:
receiving an SIB1 from the anchor cell, and
identifying the SIB-less cell based on the SIB1,
wherein the SIB1 includes identification information of the SIB-less cell related to the anchor cell, and
wherein the identification information includes one of a physical cell identifier (PCI), a cell global identifier (CGI), index information, or frequency information of the SIB-less cell.

3. The method of claim 1, wherein the identifying of the SIB-less cell comprises transmitting a radio resource control (RRC) message including identification information of the SIB-less cell to which the terminal can be accessed, to the anchor cell.

4. The method of claim 1,
wherein the identifying of the SIB-less cell comprises:
receiving a master information block (MIB) from the cell, and
identifying whether the cell is the SIB-less cell based on an indicator included in the MIB,
wherein the MIB includes at least one of an index of the SIB-less cell, resource information for random access, and information for the anchor cell, and
wherein resource information for the random access is configured for a specific purpose.

5. A method performed by a base station related to an anchor cell in a wireless communication system, the method comprising:
receiving a request of an SIB for an SIB-less cell from a terminal;
transmitting the SIB for the SIB-less cell to the terminal; and
transmitting a paging message for the SIB-less cell to the terminal,
wherein the paging message includes an indicator that indicates access to the SIB-less cell.

6. The method of claim 5, further comprising:
transmitting an SIB1 including identification information of the SIB-less cell related to the anchor cell to the terminal,
wherein the identification information includes one of a PCI, a CGI, index information, or frequency information of the SIB-less cell.

7. The method of claim 1, further comprising:
receiving an RRC message including identification information of the SIB-less cell to which the terminal can be accessed, from the terminal.

8. A terminal in a wireless communication system, the terminal comprising:
a transceiver; and
a controller configured to:
identify an SIB-less cell,
request an SIB for the SIB-less cell from an anchor cell corresponding to the SIB-less cell,
receive the SIB for the SIB-less cell from the anchor cell,
receive a paging message for the SIB-less cell from the anchor cell, the paging message including an indicator that indicates access to the SIB-less cell, and
attempt to access the SIB-less cell based on the paging message.

9. The terminal of claim 8,
wherein the controller is configured to:
receive an SIB1 from the anchor cell, and
identify the SIB-less cell based on the SIB1,
wherein the SIB1 includes identification information of the SIB-less cell related to the anchor cell, and
wherein the identification information includes one of a PCI, a CGI, index information, or frequency information of the SIB-less cell.

10. The terminal of claim 8, wherein the controller is configured to transmit an RRC message including identification information of the SIB-less cell to which the terminal can be accessed, to the anchor cell.

11. The terminal of claim 8,
wherein the controller is configured to:
receive an MIB from the cell, and
identify whether the cell is the SIB-less cell, based on an indicator included in the MIB,
wherein the MIB includes at least one of an index of the SIB-less cell, resource information for random access, and information for the anchor cell, and
wherein resource information for the random access is configured for a specific purpose.

12. A base station corresponding to an anchor cell in a wireless communication system, the base station comprising:
a transceiver; and
a controller configured to:
receive a request of an SIB for an SIB-less cell from a terminal,
transmit the SIB for the SIB-less cell to the terminal, and
transmit a paging message for the SIB-less cell to the terminal, the paging message including an indicator that indicates access to the SIB-less cell.

13. The base station of claim 12,
wherein the controller is configured to transmit an SIB1 including identification information of the SIB-less cell related to the anchor cell to the terminal, and
wherein the identification information includes one of a PCI, a CGI, index information, or frequency information of the SIB-less cell.

14. The base station of claim 12, wherein the controller is configured to receive an RRC message including identification information of the SIB-less cell to which the terminal can be accessed, from the terminal.
